(19) United States
(12) Patent Application Publication
(10) Pub. No.: US 2026/0008420 A1
(43) Pub. Date: Jan. 8, 2026

(54) CENTER CONSOLE ASSEMBLY

(71) Applicant: SUBARU CORPORATION, Tokyo (JP)

(72) Inventors: Jose Pacheco, VanBuren Twp, MI (US); Takahiro Minegishi, VanBuren Twp, MI (US)

(21) Appl. No.: 18/763,814

(22) Filed: Jul. 3, 2024

(51) Int. Cl. B60R 11/02; B60R 11/00

(52) U.S. Cl. CPC B60R 11/0241; B60R 2011/0007; B60R 2011/007; B60R 2011/0085

(57) ABSTRACT

A center console assembly for a vehicle comprises a console main body; and an electronic device holder movably attached to the console main body. The electronic device holder may comprises a wireless charging unit; a first surface configured to charge an electronic device placed on the first surface when the electronic device holder is arranged at a first rotational angle with respect to the console main body; and a second surface configured to charge an electronic device placed on the second surface when the electronic device holder is arranged at a second rotational angle with respect to the console main body, the second rotation angle being different from the first rotational angle.

### FIELD OF INVENTION

The present disclosure relates to center console assemblies for vehicles.

### BACKGROUND ART

Today many vehicles have a wireless charger at a center console to charge electronic devices while driving. In general, a wireless charger has a charging surface on which to receive a charging surface of the electronic device to be charged. Many wireless chargers adopt an electromagnetic induction method, such as Qi standard. The wireless charger has an electric coil inside or near the charging surface. The electric coil generates a certain magnetic flux which then induces an electromagnetic induction in the corresponding coil in the electronic device.

Therefore, the device’s charging surface should be correctly placed or positioned with respect to the charger’s charging surface. Accordingly, the attitude, i.e. position, angle, and the like, of the electronic device during a charging is determined by the configurational design of the wireless charger.

For example, a wireless charger is designed such that an electronic device is placed vertically for charging (Non-Patent Literature 1). Alternatively, a wireless charger supports an electronic device declined or almost horizontally for charging (Non-Patent Literature 2).

Some driver or passengers value the convenience of using the features of their electronic devices such as navigation, while ensuring the electronic devices remain charged. Meanwhile other drivers prefer not being distracted by the screens of their electronic devices while driving. Even for the same drivers, the preference in the usage of their devices may vary depending on the driving situation.

Thus the conventional wireless chargers cannot meet such demands of enabling a variety of stress-free interior usages of a car. Accordingly, a wireless charger system that allows multiple charging positions depending on the needs of the users is desired.

### Prior Art Literature

### Non-Patent Literature

Non-Patent Literature 1: JP7263664

Non-Patent Literature 2: JP2022-98831

### SUMMARY OF THE INVENTION

One general aspect of the present disclosure includes a vehicle console assembly comprising: a console main body; and an electronic device holder movably attached to the console main body. The electronic device holder includes a wireless charging unit.

In some embodiments, such a movable attachment of the electronic device holder allows the electronic device holder to be used at multiple positions, or two positions. Such a multiple or dual position wireless charger can cater to a variety of values and utilities of the drivers and passengers.

### Center Console

The term “center console” used herein generally refers to a vehicle structure located in the center and in the front of the vehicle interior. A center console may be a part of the dashboard. A center console may be located between the driver’s seat and the passenger’s seat, or may be a part of or attached to the armrest between the driver’s seat and the passenger’s seat. A center console may be a structure that extends rearwards from the dashboard, or a structure separated from the dashboard. A “center console” may house or support a wireless charger, an electric outlet, an air flow path of an air conditioner, drink-holders, storage compartments, trays and the like.

### Electronic Device Charger

The term “electronic device holder” used herein generally refers to a part or member used to charge electronic devices when they are placed or connected to the electronic device holder. In some embodiments, the electronic device holder includes or is a wireless charger. The electronic device holder does not necessarily “hold” or “affix” an electronic device to be charged. The electronic device holder may be configured such that an electronic device can just be placed on a position or a surface of the electronic device holder to allow the electronic device to be charged by the electronic device holder.

The wireless charging may employ an electromagnetic induction method. An example is the so called Qi standard (registered trademark).

In some embodiments the electronic device holder is rotatably attached to the console main body. In some embodiments, the electronic device holder may be configured to be flipped or turned over with respect to the console main body. In some embodiments, the electronic device may be movable by a combination of multiple moving mechanisms.

The electronic device holder may have multiple surfaces on each of which an electronic device is to be positioned to be charged by the wireless charging unit. The electronic device holder may be held or positioned for each of the multiple surfaces. The electronic device holder may be fixed at a certain rotational angle depending on which charging surface is to be used.

The electronic device holder may have a first surface and a second surface. The first surface may be configured such that a (first) electronic device is placed thereon and electrically charged by the wireless charging unit, when the electronic device holder is positioned at a first rotational angle. The second surface may be configured such that a second electronic device is placed thereon and electrically charged by the wireless charging unit, when the electronic device holder is positioned at a second rotational angle different from the first rotational angle.

In some embodiments, the electronic device holder is rotationally coupled to the console main body. The electronic device holder can rotate with respect to the console main body.

In some embodiments, the first surface may substantially face at least either one of the driver and the passenger when the electronic device holder is positioned at the first rotational angle. In some embodiments, at the second angle, the second surface is oriented in such a way that the display of the electronic device placed thereon is substantially invisible from the driver or the passengers or it does not disturb the safe driving. In some embodiments, the second surface is substantially vertically oriented, when the electronic device holder is positioned at the second rotational angle.

The electronic device holder may be held, keyed, or locked at predetermined positions or angles by using a certain mechanism. For example, magnets can be used. A magnet is arranged in the electronic device holder and another magnet of the other pole is arranged in another counterpart or another object such as the console main body, the dashboard and the like.

As an example, an edge of the electronic device holder has a magnet and a bottom surface of the dashboard with which the edge of the electronic device holder comes in contact at a predetermined angle has a magnet of the opposite pole. This “edge” may be the top side of the electronic device holder at this angle. As another example, an edge of the electronic device holder has a magnet and a surface of the console main body with which the edge of the electronic device holder comes in contact at a predetermined angle has a magnet of the opposite pole. This “edge” may be a part of the front side of the console main body at this angle.

A latch mechanism or a key or pin mechanism may be used. Other mechanisms, or a combination of multiple mechanisms may be used.

In some embodiments, an electronic device may be just placed on a charging surface of the electronic device holder such that it can just stay on the charging surface by gravity only. It may not be held tight with an extra mechanism. In some embodiments, an electronic device may be locked by an extra mechanism. The charging surface may have a rim to partially or entirely surround the electronic device placed thereon. Such a rim can prevent the electronic device from slipping away due to vibrations or shocks.

### Device Position Adjuster

In some embodiments, the console assembly includes a device position adjuster to adjust the position of the electronic device to a correct position for charging. The device position adjuster may be attached to, or included in, the console main body or the electronic device charging unit.

The device position adjuster may be configured to press the electronic device close to the second surface to secure a charging of the electronic device by the wireless charging unit. For example, such a device position adjuster may be configured by using a ratchet and a rack. A part that touches and the electronic device may be fixed to the ratchet. The ratchet may be fixed to the console main body. A locking element may be spring-loaded to engage with the teeth of the ratchet. There may be a mechanism that can be operated by the driver or the passenger to disengage the locking element from the ratch horizontally or vertically and to move the pressing part. The teeth of the rack or the locking element may be formed in a prismatic shape to firmly block the movement of the locking element in one direction and/or to easily move the locking element in the other direction.

### Foreign Object Detector

In some embodiments, the vehicle console main body may include a system or a unit to detect a foreign object that is not to be charged. A foreign object detection system may detect a foreign object near either one or both of the first surface and the second surface. A foreign object detection system may prevent the wireless charging unit from falsely operating when a foreign object is placed near either one or both of the first surface and the second surface.

A foreign object detection system may be included in the wireless charging unit. Alternatively, a foreign object detection system may include a wireless charging unit.

### Cooling System

The console assembly may have a cooling system to cool the electronic device during charging. In some embodiments, the console main body has an air path to guide and allow air to flow toward the electronic device holder. Thereby the electronic device placed on either one of the first surface and the second surface of the electronic device holder can be cooled.

### BRIEF DESCRIPTION OF THE DRAWINGS

Some embodiments and examples of the present disclosure will now be discussed in detail by referring to the following figures. The embodiments and examples, with reference to the accompanying drawings, are given as examples only, and they should not be interpreted as being limiting.

FIG. 1 shows a perspective view of a center console assembly at a first position, according to an example.

FIG. 2 shows a perspective view of a center console assembly at a second position, according to an example.

FIG. 3 shows a perspective view of a center console assembly at a second position, according to an embodiment.

FIG. 4 shows a cross-sectional view of a center console assembly at a first position, according to an embodiment.

FIG. 5 shows a cross-sectional view of a center console assembly at a second position, according to an embodiment.

FIG. 6 shows a cross-sectional view of a center console assembly at a second position, according to an embodiment.

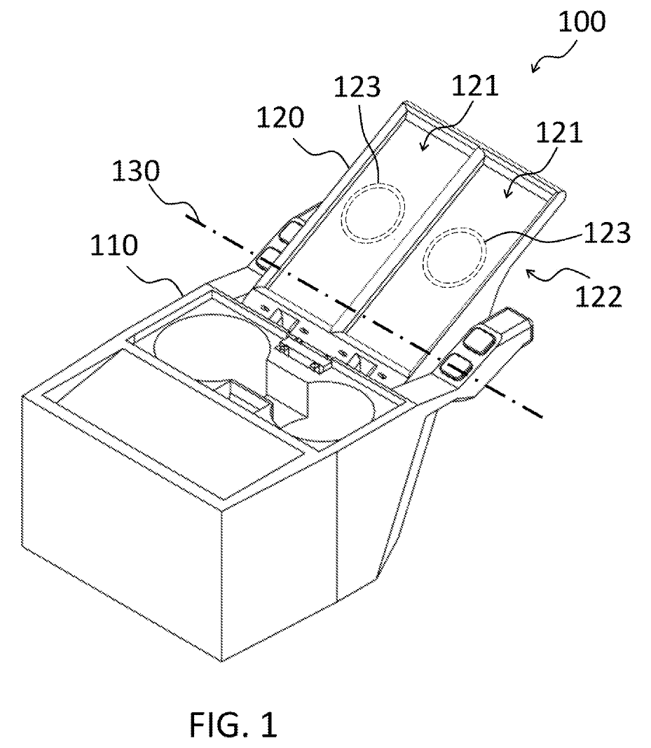

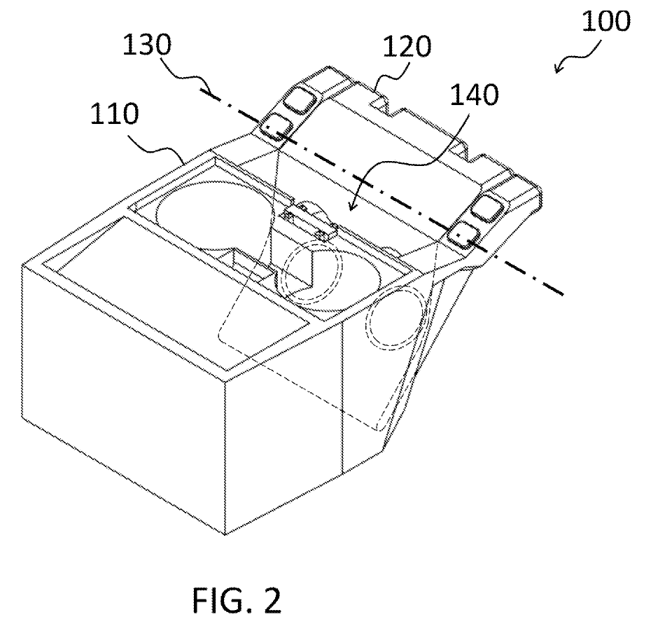

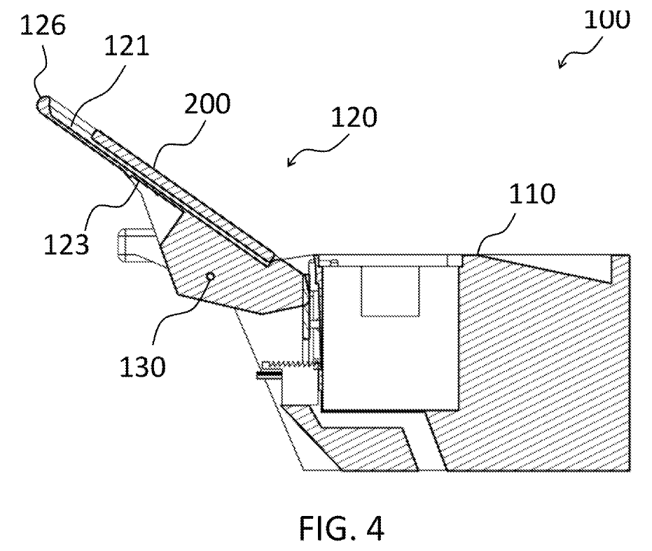

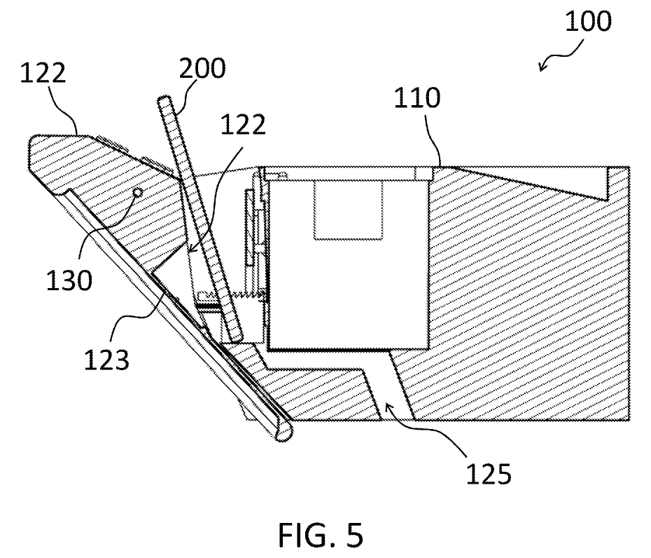

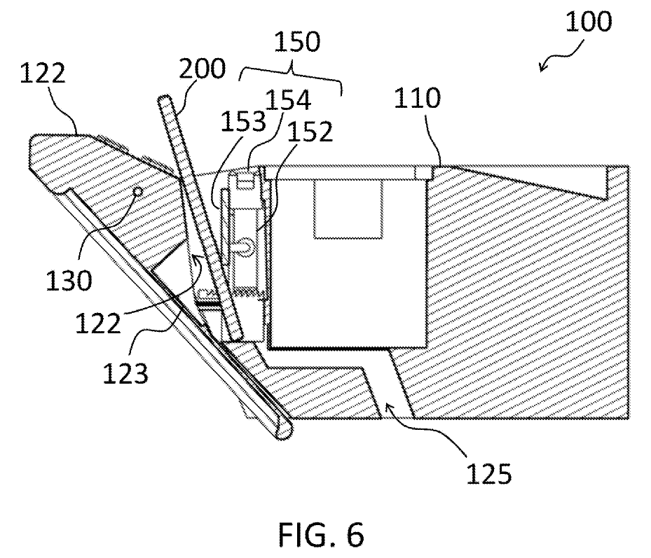

FIGS. 1 to 6 show a vehicle console assembly 100 according to an embodiment. FIG. 1 shows a perspective view and FIG. 4 shows a cross sectional view of the vehicle console assembly, when at a first angle. FIG. 2 shows a perspective view and FIGS. 5 and 6 show cross sectional views of the vehicle console assembly, when at a second angle.

The vehicle console assembly 100 includes a console main body 110 and an electronic device holder 120 rotatably attached to the console main body 110. The electronic device holder 120 can rotate around a rotational axis 130. The electronic device holder 120 includes a wireless charging unit 123. The wireless charging unit 123 is an electric coil embedded in the electronic device holder 120 or covered so as to be invisible from outside.

In FIGS. 1 and 4, a first surface 121 of the electronic device holder 120 faces upwards with an angle or a first angle. An electronic device 200 can be placed on the first surface 121 and wirelessly charged by the wireless charging unit 123.

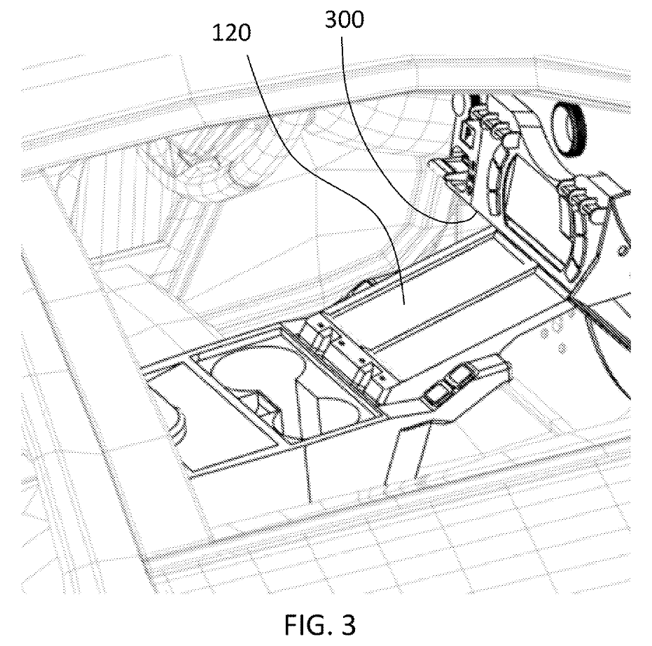

In some embodiment, the electronic device holder 120 can be held at the first angle in such a way that a first edge 126 touches a bottom surface of a dashboard 300 (see FIG. 3). For example, the first edge 126 of the electronic device holder 120 and the bottom surface of the dashboard 300 can have magnets. The electronic device holder 120 can be held at the first angle in other fashions. For example, another edge (second edge) 127 (not shown) can touch a part of the console main body 110. The other edge 127 and the part of the console main body can have magnets.

In FIGS. 2, 5 and 6, a second surface 122 of the electronic device holder 120 is held to stand almost vertically or at a second angle. An electronic device 200 can be put in a space or a pocket 140 between the second surface 122 of the electronic device holder 120 and the console main body 110. The electronic device 200 does not necessarily be placed face-to-face on the surface of the second surface 122. There can be a space between the electronic device 200 and the second surface 122 of the electronic device holder 120.

As shown in FIGS. 5 and 6, the console main body 110 may have a device position adjuster or a pressing mechanism 150 to press the electronic device 200 standing in the pocket 140 towards the second surface 122 or the electronic device holder 120 (FIG. 6). The pressing mechanism 150 has a rack 151, a ratchet 152, and a pressing part 153. The rack 151 is fixed to the console main body 110. The ratchet 152 is engaged with the teeth of the rack 151. The pressing part 153 is fixed to the ratchet 152. The ratchet 152 also has a ratchet releasing mechanism 154 that can be pressed by a user to disengage the ratchet 152. In FIG. 6 the ratchet 152 was disengaged from the rack 151 horizontally in the direction perpendicular to the longitudinal direction of the rack 151. Then the ratchet 152 and the pressing part 153 has been moved forwards to press the electronic device 200 towards the electronic device holder 120, the second surface 122, or the coil 123.

This can prevent the electronic device 200 from moving from the wireless charging unit 123, for example by vibration of the vehicle, and avoid interruption of the charging.

As shown in FIGS. 5 and 6, the console main body has an air path 115. The air path 115 is connected to an air conditioner of the vehicle at one end, and guides air from the air conditioner to the electronic device 200 standing in the pocket 140 when the electronic device holder is held at the second angle. When the electronic device 200 stands inside the pocket 140, the heat generated by the electronic device 200 may not be dissipated in an efficient manner. The air path 115 allows cooled air to hit the electronic device 200 and to take the heat of the electronic device 200 away which otherwise would cause the undesirable temperature rise of the electronic device 200 while charging.

The present disclosure also provides the following embodiments:

A001. A center console assembly for a vehicle, comprising:

a console (main) body; and

an electronic device holder movably attached to the console main body.

A002. The center console assembly according to A001 or any one of the embodiments,

wherein the electronic device holder comprises:

a wireless charging unit;

a first surface configured to charge an electronic device placed on the first surface when the electronic device holder is arranged at a first position; and

a second surface configured to charge an electronic device placed on the second surface when the electronic device holder is arranged at a second position different from the first position.

A003. The center console assembly according to A001 or any one of the embodiments,

wherein the electronic device holder comprises:

a wireless charging unit;

a first surface configured to charge an electronic device placed on the first surface when the electronic device holder is arranged at a first rotational angle with respect to the console main body; and

a second surface configured to charge an electronic device placed on the second surface when the electronic device holder is arranged at a second rotational angle with respect to the console main body, the second rotation angle being different from the first rotational angle.

A011. The vehicle console assembly according to A001, further comprising a hinge assembly coupling the console body and the electronic holder assembly.

A021. The vehicle console assembly according to A001, wherein the wireless charging unit operates under the Qi standard.

A031. The vehicle console assembly according to A001, wherein the first surface substantially faces at least either one of the driver and the passenger when the electronic device holder is positioned at the first rotational angle.

A032. The vehicle console assembly according to A001 wherein the second surface is substantially vertically oriented, when the electronic device holder is positioned at the second rotational angle.

A041. The vehicle console assembly according to A032, wherein the console body includes a device position adjuster configured to press the electronic device close to the second surface to secure a charging of the electronic device by the wireless charging unit.

A051. The vehicle console assembly according to A001, further comprising a foreign object detection system configured:

to detect a foreign object near either one or both of the first surface and the second surface, and/or

to prevent the wireless charging unit from operating if a foreign object is placed near either one or both of the first surface.

A052. The vehicle console assembly according to A031, wherein the foreign object detection system includes the wireless charging unit.

A061. The vehicle console assembly according to A001, wherein the console body has an air path to allow air to flow toward the electronic device holder, so as to cool the electronic device placed on either one or both of the first surface and the second surface of the electronic device holder.

Terms and phrases used in this application, and variations thereof, especially in the appended claims, unless otherwise expressly stated, should be construed as being open-ended rather than being closed. As examples of the foregoing, the term ‘including’ should be understood to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes, but is not limited to;’ the term ‘example’ is used to provide exemplary instances of the item in discussion, not an exhaustive or limiting list thereof.

A group of items linked with the conjunction ‘and’ should not be read as requiring that each and every one of these items be present in the grouping, but rather should be understood as ‘and/or’ unless expressly stated otherwise. Similarly, a group of items linked with the conjunction ‘or’ should not be understood as requiring mutual exclusivity among that group, but rather should be understood as ‘and/or’ unless expressly stated otherwise.

With respect to the use of substantially any plural or singular term herein in the English language, those skilled in the art can understand the plural and the singular as appropriate according to context and the use. The various singular and plural permutations may be expressly set forth herein for the sake of clarity. The indefinite article “a” or “an” does not exclude a plurality.

Any of the embodiments or any of the aspects disclosed herein is independently combinable, in part or in whole, with other embodiments described herein in any way, e.g., one, two, or three or more embodiments may be combinable in whole or in part. Furthermore, any of the features of any of the embodiments or any of the aspects disclosed herein is applicable to any of the other embodiments and aspects, or may be made optional for other embodiments or aspects.

While preferred embodiments of the present invention have been shown and described herein, it will be obvious to those skilled in the art that such embodiments are provided by way of example only. It is not intended that the invention be limited to the specific examples provided within the specification. While the invention has been described with reference to the aforementioned specification, the descriptions and illustrations of the embodiments and examples herein are not meant to be construed in a limiting sense. Numerous variations, changes, and substitutions can be conceived by those skilled in the art without departing from the concept of the invention. Furthermore, it shall be understood that no aspects of the invention are limited to the specific depictions, configurations, or relative proportions set forth herein which depend upon a variety of conditions and variables. It should be understood that various alternatives to the embodiments of the invention described herein may be employed in practicing the invention. It is therefore to be understood that the invention shall also cover any such alternatives, modifications, variations or equivalents. It is intended that the following claims define the scope of the invention and that methods and structures within the scope of these claims and their equivalents be covered thereby.

What is claimed is:

1. A center console assembly for a vehicle, comprising:
a console (main) body; and
an electronic device holder movably attached to the console main body, the electronic device holder comprising:
a wireless charging unit;
a first surface configured to charge an electronic device placed on the first surface when the electronic device holder is arranged at a first rotational angle with respect to the console main body; and
a second surface configured to charge an electronic device placed on the second surface when the electronic device holder is arranged at a second rotational angle with respect to the console main body, the second rotation angle being different from the first rotational angle.

2. The vehicle console assembly according to claim 1, wherein the wireless charging unit operates under the Qi standard.

3. The vehicle console assembly according to claim 1, wherein the first surface substantially faces at least either one of the driver and the passenger when the electronic device holder is positioned at the first rotational angle.

4. The vehicle console assembly according to claim 1, wherein the second surface is substantially vertically oriented, when the electronic device holder is positioned at the second rotational angle.

5. The vehicle console assembly according to claim 1, wherein the console body includes a device position adjuster configured to press the electronic device close to the second surface to secure a charging of the electronic device by the wireless charging unit.

6. The vehicle console assembly according to claim 1, further comprising a foreign object detection system configured
to detect a foreign object near either one or both of the first surface and the second surface, and/or
to prevent the wireless charging unit from operating if a foreign object is placed near either one or both of the first surface.

7. The vehicle console assembly according to claim 6, wherein the foreign object detection system includes the wireless charging unit.

8. The vehicle console assembly according to claim 1, wherein the console body has an air path to allow air to flow toward the electronic device holder, so as to cool the electronic device placed on either one or both of the first surface and the second surface of the electronic device holder.
